(19) United States
(12) Patent Application Publication
(10) Pub. No.: US 2013/0124396 A1
(43) Pub. Date: May 16, 2013

(54) SYSTEM AND METHOD FOR UTILIZING A MOBILE DEVICE TO PURCHASE ONE OR MORE GOODS AND SERVICES

(71) Applicant: Howard Loff, Atlantic Beach, FL (US)

(72) Inventor: Howard Loff, Atlantic Beach, FL (US)

(21) Appl. No.: 13/293,970

(22) Filed: Nov. 10, 2011

(51) Int. Cl. G06Q 20/32

(52) U.S. Cl. 705/39

(57) ABSTRACT

The present invention is a system to purchase one or more goods and services that includes one or more payment receiving apparatuses that include a distinctive product code, a mobile device with an input system to input purchasing data and a payment distribution application utilized to input purchasing data and a communications network that allows the mobile device to be in communication with the one or more payment receiving apparatuses. A payment is performed by the mobile device to purchase the goods and services provided by the one or more payment receiving apparatuses which are in communication with a user's monetary funds to transfer the user's monetary funds over the communications network to the payment receiving apparatus to purchase the goods and services.

### TECHNICAL FIELD & BACKGROUND

Typically conventional payment for products or services contained within a relatively small payment receiving apparatus such as a vending machine or a parking meter requires a user to either carry change or bills of small denominations. At times, money that is exchanged for these products or services is often mishandled and does not make its way properly to the intended parties for a credited payment for the intended product or service. Credit card terminal and smartphone payment integration into these relatively small payment receiving apparatuses shows a need for a system and method for utilizing a mobile device to purchase these goods and services into the digital age and to move away from hard cash and coin transactions involving these relatively small payment receiving apparatus.

The present invention generally relates to one or more payments of goods and services from a relatively small payment receiving apparatus and more particularly to making one or more payments using an identification method for each relatively small payment receiving apparatus such as an identifier code, a scanable graphic such as a bar code, a location indication device such as a global positioning satellite or GPS system, or a Bluetooth device. The present invention can be built into a new relatively small payment receiving apparatus or be retrofit to a relatively older relatively small payment receiving apparatus.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a block diagram of a system to utilize a mobile device to purchase one or more goods and services, in accordance with one embodiment of the present invention.

FIG. 2 illustrates a flowchart of a method for utilizing a mobile device to purchase one or more goods and services, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

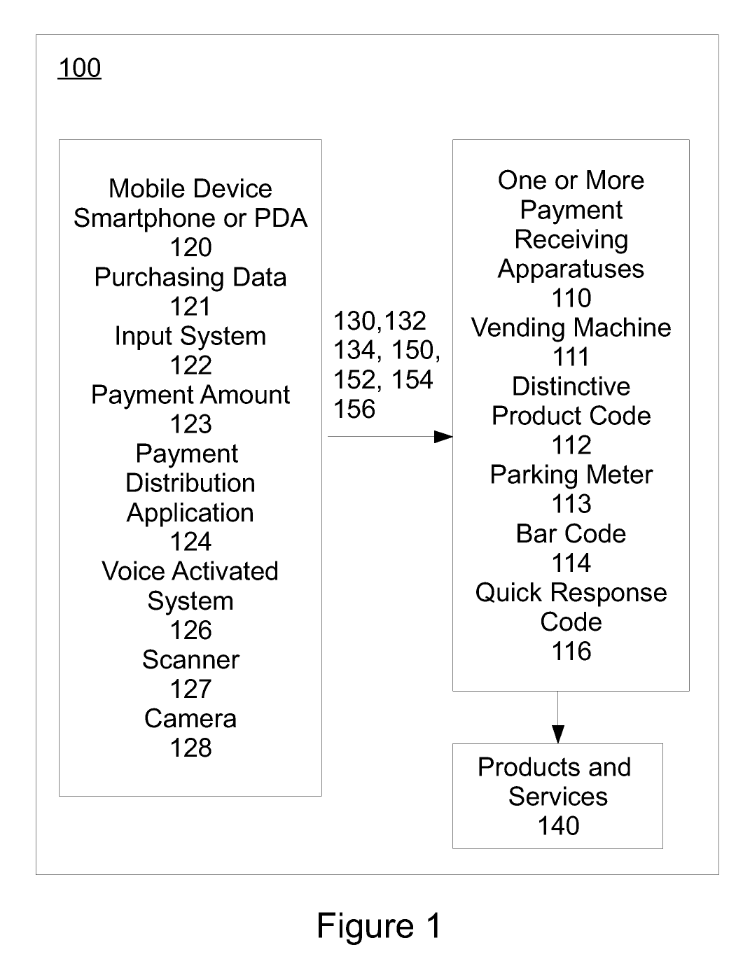

FIG. 1 illustrates a block diagram of a system 100 to utilize a mobile device to purchase one or more goods and services, in accordance with one embodiment of the present invention.

The system 100 includes one or more payment receiving apparatuses 110, a mobile device 120, a communications network 130, one or more products and services 140 and a payment 150.

The one or more payment receiving apparatuses 110 is one or more relatively small payment receiving apparatuses that can be a vending machine 111, a parking meter 113 or other suitable payment receiving apparatus. The one or more payment receiving apparatuses 110 include a distinctive product code 112 such as a bar code 114, a quick response code 116 or other suitable distinctive product code. The parking meters 113 can expire and can be replenished with payments automatically or have a reminder notifying a user to optionally replenish if desired. The system 100 can also accommodate a relatively older payment receiving apparatus 110 as well as a new payment receiving apparatus 110. The mobile device 120 can be a smartphone with an input system such as a keyboard 122, a voice activated system 124, a camera 126, a scanner 127, a mouse system, a track ball system, a track pad system, buttons on a handheld system, a scanner system, a wireless receiver, a microphone system, a connection to a sound system, and/or a connection and/or an interface system to a computer system, intranet, and/or the Internet (e.g., IrDA, USB) or other suitable input system or other suitable mobile device such as a personal digital assistant or PDA, cell phones, wireless IP devices, laptops, personal computers and a payment distribution application 128. The input system is utilized to input purchasing data 121 that includes a payment amount 123 and other suitable input purchasing data subsequently described as part of a payment 150. The communications network 130 allows the mobile device 120 to be in communication with one or more payment receiving apparatuses 110. The communications network 130 can be a wireless system 132 such as a global positioning satellite or GPS system 132, a Bluetooth system 134 or other suitable communications network. The products and services 140 are provided by the payment receiving apparatuses 110 previously described and are typically relatively small monetary transactions that are purchased with the mobile device 120. The payment 150 is performed by the mobile device 120 for the previously described products and services 140 which are in communication with a user's monetary funds to transfer the user's monetary funds over the communications network 130 to the payment receiving apparatus 110 to pay for the provided goods and services 140 to transfer the user's monetary funds to purchase the provided goods and services. Performing the payments 150 utilizing the mobile device 120 provides considerable more convenience, efficiency and assurance of payments 150 being received by the payment receiving apparatus 110 than traditional hard currency payments with cash and/or coins. The payments 150 include supplemental information such as a price 152, a merchant name 154 and a goods and services description 156 of the purchased products and services 140. The payments 150 can also be from one or more sources such as a debit card, a credit card and /or a mobile payment service. This assures that the payments 150 can be directly transferred as well as indirectly transferred by being charged to the user's mobile phone account.

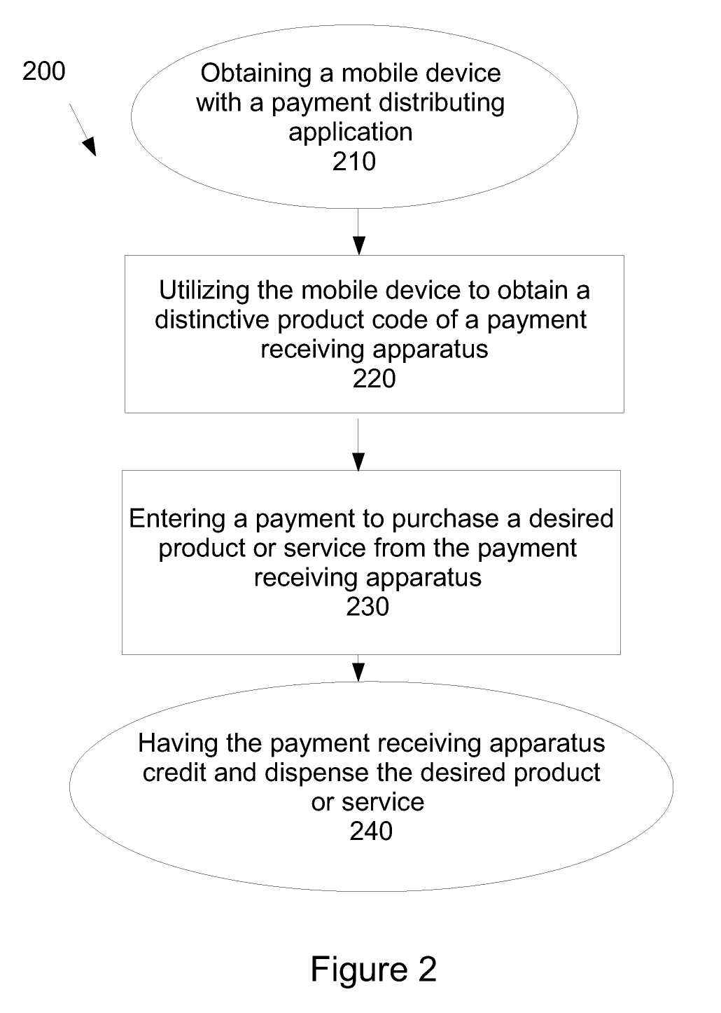

FIG. 2 illustrates a flowchart of a method 200 for utilizing a mobile device to purchase one or more goods and services, in accordance with one embodiment of the present invention.

The method 200 steps include obtaining a mobile device with a payment distributing application 210, utilizing the mobile device to obtain a distinctive product code of a payment receiving apparatus 220, entering a payment to purchase a desired product or service from the payment receiving apparatus 230 and having the payment receiving apparatus credit and dispense the desired product or service 240.

The step of obtaining a mobile device with a payment distributing application 210 includes utilizing a mobile device that can be a smartphone with an input system such as a keyboard, a voice activated system, a scanner, a camera or other suitable input system or other suitable mobile device such as a personal digital assistant or PDA. The input system is utilized to input purchasing data that includes a payment amount and other suitable input purchasing data subsequently described as part of a payment. The step of utilizing the mobile device to obtain a distinctive product code of a payment receiving apparatus 220 includes utilizing a payment receiving apparatus that includes a distinctive product code such as a bar code, a quick response code or other suitable distinctive product code. The step of entering a payment to purchase a desired product or service from the payment receiving apparatus 230 can be performed by the mobile device input system which is in communication with a user's monetary funds to transfer the user's monetary funds over a communications network to the payment receiving apparatus to pay for the provided goods and services. The step of having the payment receiving apparatus credit and dispense the desired product or service 240 includes utilizing the mobile device which provides considerable more convenience, efficiency and assurance of payments being received by the payment receiving apparatus than traditional hard currency payments with cash and/or coins.

The system includes first capturing an image of a specific identifier code displayed on a payment receiving apparatus, as by taking a picture of the code with a camera built into the phone. Additionally a machine can be specifically identified and linked with a mobile device through a multitude of possibilities such as location-based technology such as GPS technology, Bluetooth technology, or even a relatively simple manual input of a code displayed on the payment receiving apparatus by the user. The mobile device identifies and distinguishes one payment receiving apparatus against another payment receiving apparatus and includes sufficient information about the products and services offered as to allow the user to purchase and pay for the desired products and/or services. Once the payment receiving apparatus is linked with the mobile device, the mobile device can be used to obtain the array of products and services such as price, merchant, and description associated with the specific payment receiving apparatus. The user may enter an amount they desire to be credited on the selected machine or select the products and services for purchase from the payment receiving apparatus via the mobile device. Purchases may be accomplished with a simple payment button on the mobile device screen that the user selects. Product and payment information may then be transmitted by the mobile device to the payment receiving apparatus to process the payment to the appropriate recipient. The system can be built into a new payment receiving apparatus or can be retrofit to an older existing payment receiving apparatus.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A system to purchase one or more goods and services, comprising:
one or more payment receiving apparatuses that include, a distinctive product code;
a mobile device with an input system and a payment distribution application utilized to input purchasing data;
a communications network that allows said mobile device to be in communication with said one or more payment receiving apparatuses; and
a payment that is performed by said mobile device to purchase said goods and services provided by said one or more payment receiving apparatuses which are in communication with a user's monetary funds to transfer said user's monetary funds over said communications network to said payment receiving apparatus to purchase said goods and services.

2. The system according to claim 1, wherein said payment receiving apparatuses are a vending machine or a parking meter.

3. The system according to claim 1, wherein said payment receiving apparatuses expire and are replenished with one or more payments automatically or have a reminder notifying said user to optionally replenish.

4. The system according to claim 1, wherein said distinctive product code is a bar code.

5. The system according to claim 1, wherein said distinctive product code is a quick response code.

6. The system according to claim 1, wherein said mobile device is a smartphone.

7. The system according to claim 1, wherein said mobile device is a personal digital assistant, a cell phone, a wireless IP device, a laptop or a personal computer.

8. The system according to claim 1, wherein said input system is a keyboard or a voice activated system.

9. The system according to claim 1, wherein said input system is a camera or a scanner.

10. The system according to claim 1, wherein said purchasing data is a payment amount.

11. The system according to claim 1, wherein said communications network is a wireless system.

12. The system according to claim 11, wherein said communications network is a global positioning satellite system.

13. The system according to claim 11, wherein said communications network is a Bluetooth system.

14. The system according to claim 1, wherein said payments include a price, a merchant name and a goods and services description of said purchased goods and services.

15. The system according to claim 1, wherein said payments are from one or more sources that include a debit card, a credit card or a mobile payment service.

16. The system according to claim 1, wherein said system provides more convenience, efficiency and assurance of said payment being received by said payment receiving apparatus than one or more hard currency payments with cash or coins.

17. A method for purchasing one or more goods and services with a mobile device, comprising the steps:
obtaining said mobile device with a payment distributing application;
utilizing said mobile device to obtain a distinctive product code of a payment receiving apparatus;
entering a payment to purchase one or more desired said goods or services from said payment receiving apparatus; and
having said payment receiving apparatus credit and dispense said desired goods or services.

18. The method according to claim 17, wherein said obtaining said mobile device with said payment distributing application includes utilizing said mobile device that is a smartphone with an input system such as a keyboard, a voice activated system, a scanner or a camera.

19. The method according to claim 17, wherein said utilizing said mobile device to obtain said distinctive product code of said payment receiving apparatus includes utilizing said payment receiving apparatus that includes a distinctive product code that includes a bar code or a quick response code.

20. The method according to claim 17, wherein said having said payment receiving apparatus credit and dispense said desired product or service includes utilizing said mobile device which provides more convenience, efficiency and assurance of said payment being received by said payment receiving apparatus than one or more hard currency payments with a plurality of cash or coins.
